(19) United States
(12) Patent Application Publication
(10) Pub. No.: US 2009/0136786 A1
(43) Pub. Date: May 28, 2009

(54) SILICON SUBSTRATE FOR MAGNETIC RECORDING MEDIUM AND MAGNETIC RECORDING MEDIUM

(75) Inventors: Katsuaki Aida, Chiba (JP); Hiroyuki Machida, Chiba (JP)

Correspondence Address: SUGHRUE MION, PLLC, 2100 PENNSYLVANIA AVENUE, N.W., SUITE 800, WASHINGTON, DC, 20037, US

(73) Assignee: SHOWA DENKO, Minato-ku, Tokyo (JP)

(21) Appl. No.: 12/067,912

(22) PCT Filed: Sep. 12, 2006
(86) PCT No.: PCT/JP2006/318471

§ 371 Date: Mar. 24, 2008

Related U.S. Application Data
(60) Provisional application No. 60/723,953, filed on Oct. 6, 2005.

(30) Foreign Application Priority Data
Sep. 22, 2005 (JP) 2005-276758

(51) Int. Cl. G11B 5/73; G11B 5/82

(52) U.S. Cl. 428/846.2

(57) ABSTRACT

A silicon substrate for a magnetic recording medium in which the substrate has a chamfered surface between its data-carrying surface (surface) having layers including a magnetic layer and its outer peripheral end surface (straight surface) is provided. The silicon substrate is characterized in that a dub-off value at an outer peripheral side of the data-carrying surface is not more than 120 Å wherein when a first position (A) is a point on the data-carrying surface radially and inwardly positioned at 1 mm from the outer peripheral end surface of the substrate, a second position (B) is a point on the data-carrying surface radially and inwardly positioned further at 1.6 mm from the first position (A), and further, provided that a perpendicular line is dropped to a straight line (A-B) connecting the first position (A) with the second position (B), a third position (C) is a point crossing the perpendicular line with the data-carrying surface and a fourth position (H) is a point crossing the perpendicular line with the straight line (A-B), the dub-off value is defined as the maximum value of the distance (C-H) between the third position (C) and the fourth position (H). Using this silicon substrate, a small avalanche point, for a higher recording density, can be obtained for the magnet recording medium. A magnetic recording medium using this silicon substrate is also provided.

### CROSS REFERENCE TO RELATED APPLICATION

This application is an application filed under 35 U.S.C. §111(a) claiming benefit, pursuant to 35 U.S.C. §119(e)(1), of the filing date of the Provisional Application No. 60/723,953 filed on Oct. 6, 2005, pursuant to 35 U.S.C. §111(b).

### TECHNICAL FIELD

The present invention relates to a magnetic recording medium widely used as a recording medium in a variety of electronic devices (computers and others), and a silicon substrate suitably usable as a substrate in the formation of the magnetic recording medium.

### BACKGROUND ART

Recently, with the development of various technologies, the recording capacity of a magnetic recording device has been increased. In particular, magnetic discs, which are principally utilized as an external memory for computers, are increasing in both recording capacity and recording density, from year to year, and are required to be further developed for recording at a higher density. For example, as a result of the development of notebook-type personal computers, it is desired to provide small and impact-resistant recording devices, and thus it is also desired to provide a small magnetic recording medium capable of recording at a higher density and having a resistance to impact. More recently, there is a tendency to utilize ultra-small magnetic recording devices in car navigation systems and portable music reproducing systems.

Heretofore, an aluminum alloy substrate, an aluminum alloy substrate having a NiP-plated surface and a glass substrate were utilized as a substrate for the magnetic recording medium. However, the aluminum alloy substrate has a poor wear resistance and workability and, to overcome these drawbacks, the substrate is further subjected to a NiP plating. The NiP-plated aluminum alloy substrate can easily produce curvature and, further, can cause defects such as magnetization upon being treated at a higher temperature. Further, the glass substrate suffers from the problems that the substrate can produce a strain layer in a surface thereof, thereby causing compression stress, during the reinforcing processing, and also can easily produce curvature upon heating of the substrate.

In the field of substrates for magnetic recording devices, they are required to have mechanical characteristics such as a high stiffness so that the substrate can withstand the reduction of the thickness of the substrate as a result of the reduction of the weight thereof and avoid deformation of the disc during high-speed rotation. In addition, it is highly required to increase the recording density. To attain a high recording density, the flying height of the magnetic head, above the substrate of the magnetic recording medium, is reduced to a very small distance, and to attain this, it is required that the substrate of the magnetic recording medium is very flat such as a mirror surface and has a small surface roughness. Moreover, it is required that defects such as micro-scratches, micro-pits and the like, are removed as much as possible from a surface of the substrate.

For an ultra-small magnetic recording medium, it is desired that the substrate is thinner, is resistant to deformation during application of an external force, has a flat surface and is made of a material capable of easily forming a magnetic recording layer.

Thus, a suggestion has been made to use, as a substrate for the magnetic recording medium, a silicon substrate which is widely utilized as a substrate of a semiconductor device (see, for example, Japanese Unexamined Patent Publication (Kokai) No. 6-76282).

In the field of semiconductors, single crystalline silicon is used to realize a clean substrate surface which has flatness comparable to the mirror surface and a small surface roughness and is free, as much as possible, from surface defects such as micro-scratches and micro-pits. In addition, compared with aluminum, silicon has many advantages such as a smaller specific gravity, a larger Young's modulus, a smaller thermal expansion, good characteristics at an elevated temperature, and a good electrical conductivity and, thus, silicon is preferable as a substrate material for a magnetic recording medium. Moreover, because an impact received by the substrate is reduced with a reduction in the diameter of the substrate, it becomes possible to provide a durable magnetic recording apparatus even when a silicon substrate is used.

Generally, when the head is flying over the disc, the head must be stable operated and as close to the disc as possible. In the absence of such a close alignment of the disc and head, there arise troubles in high-speed recording or reading and in high-density recording. In such a case, the distance between the disc and the head for stably flying the head without contact with the head is called an “avalanche point”. Defective signals will suddenly increase when the flying height is lower than the avalanche point.

In the magnetic recording disc, a wide area extends to an outer peripheral portion, if possible, is utilized to increase the recording capacity of the disc. However, in comparison with a data-carrying surface, an outer peripheral portion of the disc has poor flatness, and many improvements have been applied to an outer end configuration of the disc (see, for example, Japanese Unexamined Patent Publication (Kokai) No. 5-1290365).

Recently, the flying height of the head has been strongly required to be further reduced to reply to the need for high-density recording. However, when using the prior art silicon substrate, it was difficult to obtain a small avalanche point.

### DISCLOSURE OF THE INVENTION

An object of the present invention is to provide a magnetic recording medium capable of solving the prior art problems described above and to provide a silicon substrate capable of being suitably used in such a magnetic recording medium.

Another object of the present invention is to provide a silicon substrate for a magnetic recording medium capable of providing a small avalanche point, to allow a higher recording density, and to provide a magnet recording medium using the silicon substrate.

These and other objects of the present invention will be easily understood from the following detailed description of the preferred embodiments of the present invention.

As a result of concentrated study, the inventors of this application have found that controlling of the dub-off values in an outer side area of the data-carrying surface of the silicon substrate to a certain level is very effective to attain the above objects and, based on this finding, the present invention was conceived.

In one aspect thereof, the present invention provides a silicon substrate for a magnetic recording medium in which the substrate has a chamfered surface between its data-carrying surface (surface) for forming layers including a magnetic layer and its outer peripheral end surface (straight surface), characterized in that the dub-off value at an outer peripheral side of the data-carrying surface is not more than 120 Å and wherein, when a first position (A) is a point on the data-carrying surface radially and inwardly positioned 1 mm from the outer peripheral end surface of the substrate, a second position (B) is a point on the data-carrying surface radially and inwardly positioned further 1.6 mm from the first position (A) and, further, provided that a perpendicular line is dropped to a straight line (A-B) connecting the first position (A) with the second position (B), a third position (C) is a point crossing the perpendicular line with the data-carrying surface and a fourth position (H) is a point crossing the perpendicular line with the straight line (A-B), the dub-off value is defined as the maximum value of the distance (C-H) between the third position (C) and the fourth position (H).

In the silicon substrate for a magnetic recording medium according to the present invention, it is preferred that the outer peripheral side of the data-carrying surface has a roll-off configuration.

In another aspect thereof, the present invention provides a magnetic recording medium comprising the silicon substrate, for a magnetic recording medium according to the present invention, and at least one magnetic recording layer applied on the data-carrying surface of the substrate.

Using the silicon substrate for a magnetic recording medium or the magnetic recording medium according to the present invention having the above-described constitutional features, it becomes possible to obtain a small and suitable avalanche point. According to the inventors' findings, the reason is considered to reside in the following points:

That is, in the prior art silicon substrate for a magnetic recording medium, there could be found remarkably fine slope-like protrusions (ski-jump) and sags (roll-off) in a peripheral portion of the magnetic disc, and therefore it is considered that the magnetic head would fly in an unstable mode, and thus a small and suitable avalanche point could not be obtained.

Contrary to this, in the present invention, as a certain dub-off portion is applied to an outer peripheral side on the data-carrying surface of the silicon substrate as described above, it becomes possible to inhibit or remove any slope-like protrusions (ski-jump) and sags (roll-off) in an outer peripheral portion of the magnetic disc. As a result, it is considered that a small and suitable avalanche point can be obtained in the magnetic disc.

### BRIEF DESCRIPTION OF THE DRAWINGS

FIG. 1 is a simplified perspective view (a) and cross-sectional view (b) illustrating a basic embodiment of the silicon substrate according to the present invention;

FIG. 2 is a simplified and enlarged cross-sectional view illustrating the silicon substrate of FIG. 1 having a roll-off configuration;

FIG. 3 is a simplified and enlarged cross-sectional view illustrating the silicon substrate of FIG. 1 having a ski-jump configuration;

FIG. 4 is a view illustrating the indication section for the measurement results in the measurement apparatus Micro-Xam;

FIG. 5 is a view illustrating the indication section for the measurement target in the measurement apparatus Micro-Xam;

FIG. 6 are graphs (a) and (b) showing an example of the monitor display in the measurement apparatus Micro-Xam; and

FIG. 7 is a graph showing a relationship between the avalanche point and the dub-off value.

### BEST MODE FOR CARRYING OUT THE INVENTION

Hereinafter, the present invention will be further described with reference to the drawings, if necessary. Note in the following descriptions that the “part” and “%” indicating the volume and ratio are based on a weight, unless otherwise noted.

### (Silicon Substrate)

The silicon substrate of the present invention has a chamfered surface between its data-carrying surface (surface), having layers including a magnetic layer, and its outer peripheral end surface (straight surface), and the silicon substrate has a dub-off value, at an outer peripheral side of the data-carrying surface thereof, of not more than 120 Å.

### One Basic Embodiment

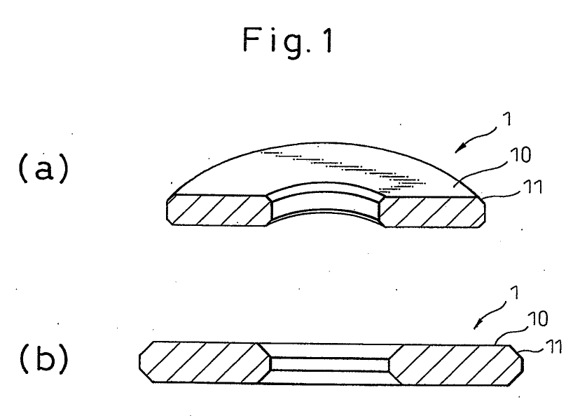

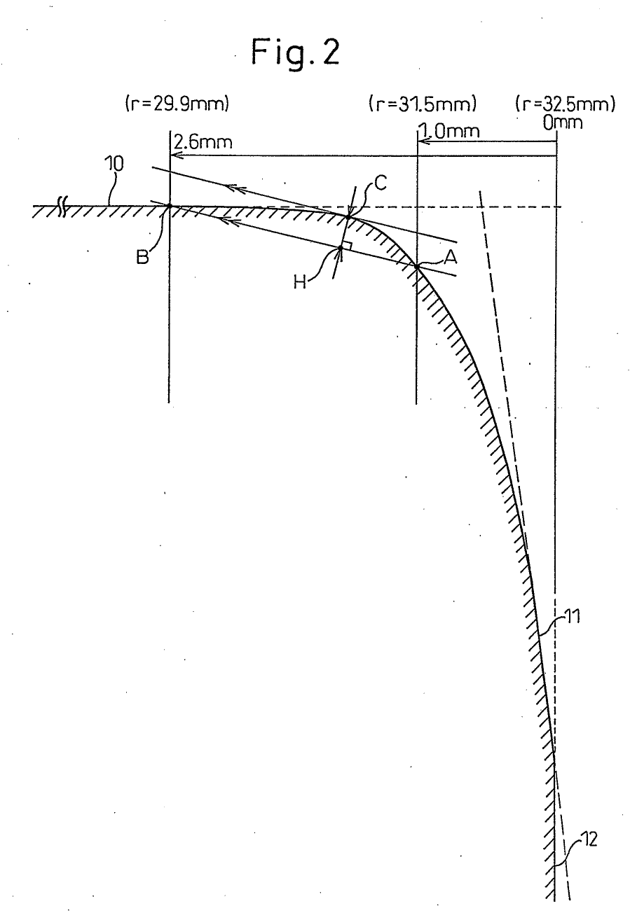

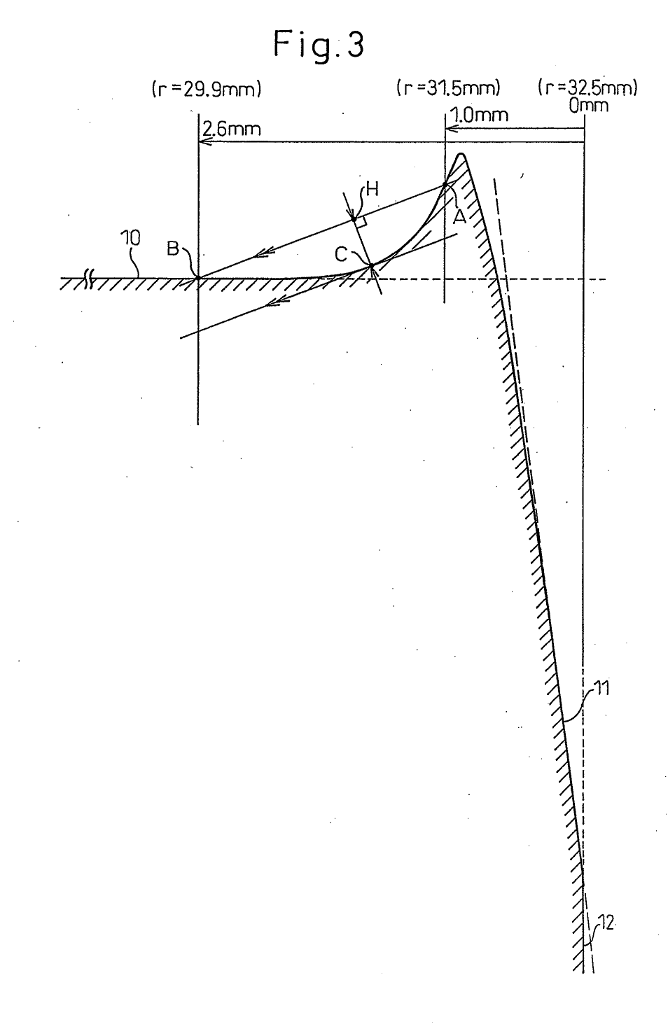

FIG. 1 is a simplified perspective view (a) and cross-sectional view (b) illustrating a basic embodiment of the silicon substrate 1 of the present invention. FIGS. 2 and 3 are each an enlarged cross-sectional view at the outermost end portion of the silicon substrate 1 of the present invention. In these FIGS. 1 to 3, illustrated is a silicon substrate 1 which has a chamfered surface 11 between its data-carrying surface 10, having layers including a magnetic layer, and its outer peripheral end surface (straight surface) 12. Note, in these drawings, that a dimension of the substrate is not proportional to the real size of the substrate, and in FIGS. 2 and 3, its dimension is remarkably enlarged particularly in the longitudinal direction. Further, a value of the radius “r” in FIGS. 2 and 3 is that obtained when the substrate has a diameter of 65 mm.

### (Determination of Dub-Off Value)

The substrate is described as having a roll-off configuration when, as is illustrated in FIG. 2, the data-carrying surface 10 is positioned beyond the straight line (A-B) which lines a point (A), on the data-carrying surface 10 and positioned at a distance of 11.0 mm in a radial and inward direction from the outer peripheral end surface 12 of the substrate, with a point (B), on the data-carrying surface 10 and positioned at a further distance of 1.6 mm (i.e., totally 2.6 mm) in a radial and inward direction from the point (A). Further, the substrate is described as having a ski-jump configuration, when the data-carrying surface 10 is positioned beneath the straight line (A-B). Note that generally the chamfered surface 11 is contained in a width of about 0.1 to 0.2 mm in an inner area from the outer peripheral end surface 12 of the substrate.

With regard to the present invention, the dub-off value is defined as the maximum value of the distance (C-H) between the crossing point (C) and the crossing point (H), as is illustrated in FIGS. 2 and 3, in both of the cases in which the substrate has a roll-off configuration or a ski-jump configuration. Here, the point (C) is a crossing point on a perpendicular line, from the straight line (A-B), with the data-carrying surface, and the point (H) is a crossing point on the perpendicular line and the straight line (A-B). In the present invention, the dub-off value is not more than 120 Å. When the dub-off value is beyond 120 Å, it becomes difficult to obtain a suitable avalanche point.

### (Silicon Material)

Attention is made to a silicon substrate for a magnetic recording medium, because the substrate has a higher stiffness and a conformability to the thinning thereof, and in addition, it can realize merits such as higher impact resistance and the like. A silicon material for this substrate is available in the form of single crystalline, poly-crystalline or amorphous material.

### (Suitable Silicon Material)

A silicon material suitably usable in the present invention is not restricted to a special-material, insofar as it can form a silicon substrate having the specified dub-off portion described above.

### (Production of Silicon Substrate)

A method of producing a silicon substrate usable in the present invention is not restricted to the special production method, insofar as it can form a silicon substrate having the specified dub-off portion described above.

### (Magnetic Recording Medium)

The magnetic recording medium of the present invention has a magnetic recording layer on a data-carrying surface of the silicon substrate of the present invention described above. A formation method of the magnetic recording layer is not restricted to a special method, insofar as it does not substantially adversely effect the effects of the silicon substrate of the present invention having the specified dub-off portion described above.

### EXAMPLES

The present invention will be further described with reference to the examples thereof.

### (Measurement Conditions of Dub-Off Values)

The measurement apparatus (Trade name: Micro-Xam, produced by ADE Phaseshift Co.) was used to determine a dub-off value of the disc. The measurement conditions used herein are as follows:
1. Disc size: 65 mm
2. Number of samples: 1 sheet (two surfaces)/batch
3. Measurement points: measured at total two points, one random point per each surface and another point rotated at 180 degree from the above measurement point
4. Others

TABLE 1

| Measurement | |
|---|---|
| apparatus | Micro-Xam |
| Objective | X2.5 |
| lens | |
| Disc diameter | 65,000 μm |
| Inner fit | 29,900 μm |
| radius | |
| Inner chord | 29,900 μm |
| radius | |
| Dub-off | 31,500 μm |
| radius | |
| Internal lens | X0.62 |
| Chamfer | 150 μm |
| length | |
| Outer fit | 31,500 μm |
| radius | |
| Outer chord | 31,500 μm |
| radius | |

### (Reading of Dub-Off Values)

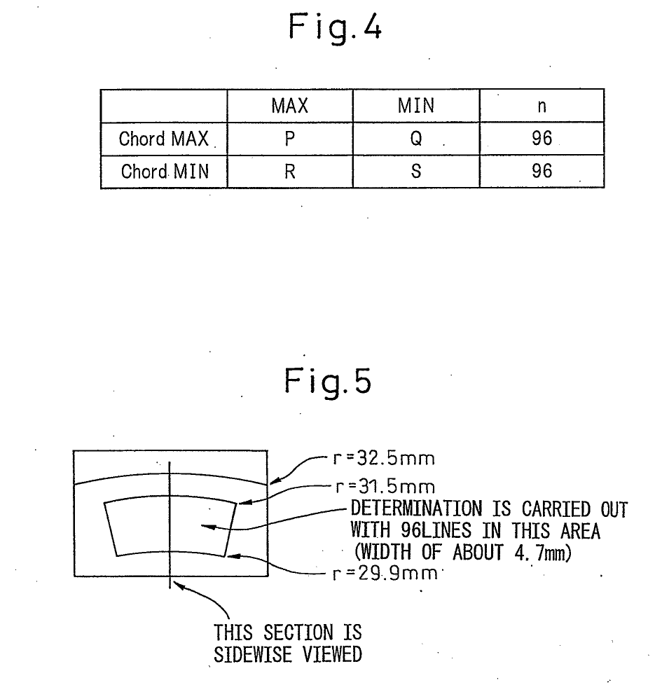

In the indication section, as illustrated in FIG. 4, of the above-described measurement apparatus, comparison was made between an absolute value of the numerical value in the column “P” and an absolute value of the numerical value in the column “S” to read the larger one as the dub-off value. Here, in the indication section of FIG. 4, the numerical value of the column “P” means the maximum value of the distance between C and H for the roll-off configuration illustrated in FIG. 2, and the numerical value of the column “S” means the maximum value of the distance between C and H for the ski-jump configuration illustrated in FIG. 3. Note that the numerical values in each of the columns “R” and “S” are indicated with minus, but the dub-off value of the present invention is evaluated by the absolute value.

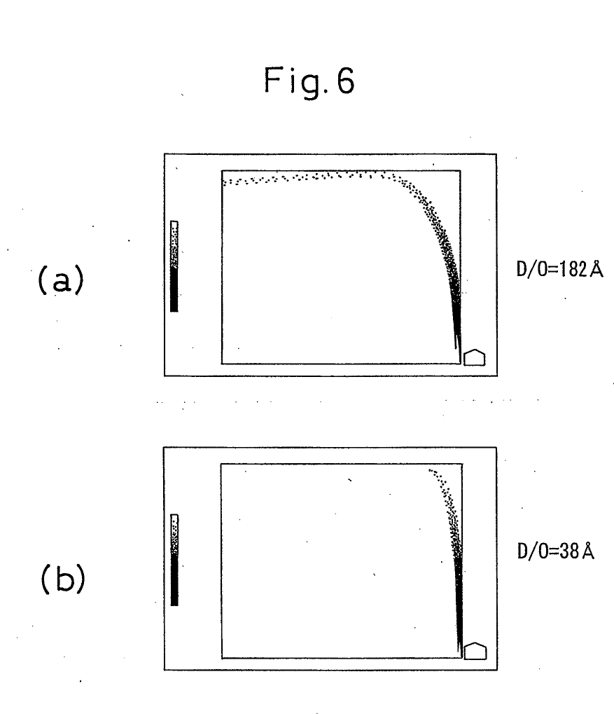

In the indication section illustrated in FIG. 4, it is described that “n” is 96. This means that measurement is carried out for 96 lines by selecting the measurement target area (about 5.2 mm×3.6 mm), indicated in the indication section of the measurement apparatus and shown in FIG. 5, from the lens, followed by dividing the area having a width of about 4.7 mm of the measurement target area into 96 lines. The maximum and minimum values for the data obtained in these 96 lines are indicated in the indication section illustrated in FIG. 4. For the reference, some examples of the practical images obtained are described in FIG. 6 in which “%” means a dub-off value.

### [Example]

Generally, the silicon substrate is produced in accordance with the following steps. That is, a disc-like silicon is first subjected to a lapping process for improving a configuration accuracy and dimensional accuracy of the substrate. Many of recently available disc-like silicon substrates have an outer diameter of about 200 mm. The lapping processing is carried out at two stages in the following lapping apparatus to obtain a finished surface accuracy of not more than 1 μm and a surface roughness Rₘₐₓ of not more than 6 μm.

After the first lapping stage has been completed, the resulting silicon substrate generally has a size larger than that desired for the substrate of the magnetic recording medium, and thus the substrate is then subjected to a laser scrubber to obtain a substrate having suitable inner and outer diameters. Thereafter, the outer peripheral and inner peripheral portions of the substrate are subjected to the predetermined chamfering processing. In this chamfering processing step, a surface roughness Rₘₐₓ at inner and outer peripheral end portions of the resulting substrate are controlled to about 4 μm. Next, the substrate is subjected to the second lapping stage to obtain a surface accuracy of not more than 1 μm and a surface roughness Rₘₐₓ of not more than 6 μm.

Next, a chamfered area in the inner and outer peripheral portions of the substrate is subjected to a polishing processing to finish a mirror surface in the substrate. Finally, a main surface of the substrate to which a magnetic recording layer is applied is subjected to a further polishing processing. This polishing processing is divided into two stages which comprise a primary polishing processing for removing scratches and strains formed during the previous processing, and a secondary polishing processing for finishing a mirror surface.

The primary polishing processing is carried out using the conventional double-ended grinding machine, and a mixture of colloidal silica and water is used as the polishing solution. Next, a secondary polishing processing for finishing is applied to the primary polishing-processed silicon substrate. The polishing conditions of the secondary polishing processing as the finish polishing is carried out using a polishing solution of colloidal silica and water. A grain size of the polishing agent used is smaller than that of the primary polishing processing. In this example, the polishing conditions were varied at several different levels to produce samples with different dub-off values.

After the secondary polishing processing step has been completed, the silicon substrate is dipped, in sequence, in each of the washing baths of an aqueous solution of ammonia and hydrogen peroxide, pure water, a mixture of pure water and IPA (isopropyl alcohol), and IPA (vapor drying) for ultrasonic washing.

A silicon substrate for a magnetic recording medium having a roll-off configuration is obtained through the above-described processing steps.

A CrMo underlayer, a CoCrPtTa magnetic layer and a hydrogenated carbon protective layer are sequentially deposited to the both surfaces of the obtained silicon substrate for a magnetic recording medium in accordance with a well-known conventional method, for example, using an in-line type sputtering apparatus and others, and then a lubricating layer of perfluoropolyether liquid is deposited, by a dipping method, to obtain a magnetic recording medium.

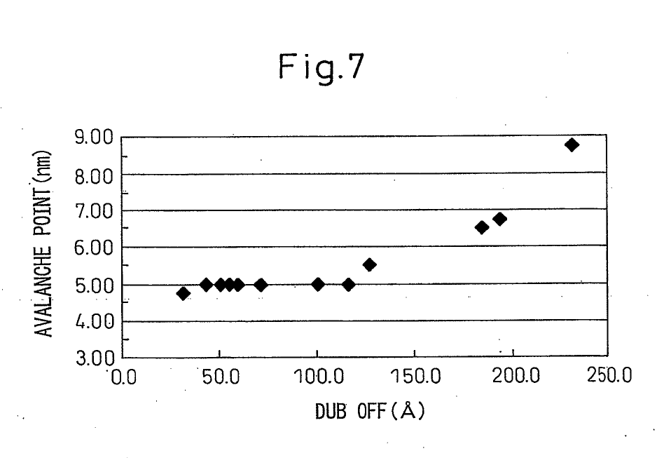

In the resulting magnetic recording medium, an avalanche point at the outer peripheral portion thereof was evaluated using the media defects evaluation apparatus (Graid Tester). The results are indicated in Table 2 and FIG. 7.

TABLE 2

| No. | Dub-off Value (A) | Avalanche Point (nm) |
|---|---|---|
| 1 | 31.2 | 4.75 |
| 2 | 43.5 | 5.00 |
| 3 | 51.0 | 5.00 |
| 4 | 55.7 | 5.00 |
| 5 | 59.6 | 5.00 |
| 6 | 71.3 | 5.00 |
| 7 | 101.1 | 5.00 |
| 8 | 116.3 | 5.00 |
| 9 | 127.1 | 5.50 |
| 10 | 184.5 | 6.50 |
| 11 | 194.0 | 6.75 |
| 12 | 230.3 | 8.75 |

As can be appreciated from Table 2 and FIG. 7, when the dub-off value is 120 Å or less, the avalanche point is a value of 5 nm or less. Contrary to this, when the dub-off value is above 120 Å, it has found the avalanche point suddenly increases.

### INDUSTRIAL APPLICABILITY

As described above, according to the present invention, a silicon substrate for a magnetic recording medium which enables a small and suitable avalanche point for increasing recording density, and a magnetic recording medium using such a substrate, are provided.

1. A silicon substrate for a magnetic recording medium in which the substrate has a chamfered surface between its data-carrying surface (surface) having layers including a magnetic layer and its outer peripheral end surface (straight surface), characterized in that a dub-off value at an outer peripheral side of the data-carrying surface is not more than 120 Å wherein when a first position (A) is a point on the data-carrying surface radially and inwardly positioned at 1 mm from the outer peripheral end surface of the substrate, a second position (B) is a point on the data-carrying surface radially and inwardly positioned further at 1.6 mm from the first position (A), and further, provided that a perpendicular line is dropped to a straight line (A-B) connecting the first position (A) with the second position (B), a third position (C) is a point crossing the perpendicular line with the data-carrying surface and a fourth position (H) is a point crossing the perpendicular line with the straight line (A-B), the dub-off value is defined as the maximum value of the distance (C-H) between the third position (C) and the fourth position (H).

2. The silicon substrate for a magnetic recording medium as defined in claim 1 in which the outer peripheral side of the data-carrying surface has a roll-off configuration.

3. A magnetic recording medium comprising the silicon substrate for a magnetic recording medium described in claim 1 and at least one magnetic recording layer applied on the data-carrying surface of the substrate.

4. A magnetic recording medium comprising the silicon substrate for a magnetic recording medium described in claim 2 and at least one magnetic recording layer applied on the data-carrying surface of the substrate.
